(19) United States
(12) Patent Application Publication
(10) Pub. No.: US 2003/0234780 A1
(43) Pub. Date: Dec. 25, 2003

(54) Power management system for liquid crystal displays

(75) Inventors: Chang-Fa Hsieh, Banchiau City (TW); Min-Jye Chen, Miaoli City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/456,265

(22) Filed: Jun. 6, 2003

(30) Foreign Application Priority Data
Jun. 20, 2002 (TW) 91113471

(51) Int. Cl. G09G 5/00

(52) U.S. Cl. 345/212

(57) ABSTRACT

A power management system for liquid crystal power supply. The system uses a power input switching device and a detecting device to close the power supply when the power supply enters a power-down mode.

### BACKGROUND OF THE INVENTION

1. Field of the Invention

The invention relates to a power management system. In particular, the invention relates to a power management system for a liquid crystal power supply, which cuts off the LCD power supply that has entered a power-down mode, thereby saving power.

2. Description of the Prior Art

For power saving requirement, a lot of hardware and software of a computer system are designed with power management functions. Major computer systems are powered by power supply that is powered by an external power source. Some peripherals such as Compact Disc Read-Only Memory (CD_ROM) drives, LCD displays can be powered by computer system itself because of low power consumption. Generally, power management system for a computer system can be divided into two types as below. One type uses Operating System (OS) or Power Management software to detect operating states of current peripherals. For example, current drive may switch from a normal mode to a power-down mode under the conditions of no disc in a CD_ROM drive or no fetch to a CD disk for a long time. The switching method is to output a standby signal to drive's power supply. After the standby signal is received, the power supply will change the supplied voltage from normal level to power-down level. The second type of a power management system uses switching devices that located on the case or any obvious location of the computer system or its peripherals, to switch the supplied voltage from normal to power-down. The above two types of power management systems can both achieve the power save purpose. FIG. 1 is a block diagram of a typical power management system. The system adapts to a display devise and uses an external power source to provide line voltage S6 to a power supply 14 first and then to display 16 by an operating power S2. The operating power S2 can be a normal power level or a power-down power level. The power supply 14 receives a synchronization signal S0 from the computer system 10. When the computer system is operating at normal, the signal S0 is in an enable state and so the power supply 14 provides the display 16 with a normal power level. When the computer system enters a power-down state or a power off state, the signal S0 is disable, the power supply 14 powers the LCD 16 with the power-down power. However, when the computer system 10 output the signal S0 with the disable state, the power supply 14 still provides a power-down power to the display 16 and so the display 16 continues to consume the power so that the power save performance is reduced.

### SUMMARY OF THE INVENTION

Accordingly, an object of the invention is to provide a power management system for a display, which uses a power input switching device and a detecting device to cut off the power supply when the power supply enters a power-down mode. The power management system can be installed in the internal power system or in an external power adaptor of a display.

The invention provides a power management system suitable for a display, i.e. a liquid crystal display (LCD), where the LCD enters an operation of normal mode or power-down mode according to a synchronization signal being enable or disable states. The system includes a power supply to convert line voltage of a power source and thus provides a converted voltage to the LCD; a power input switching device implemented between the power supply and the power source; and a detecting device detected the synchronization signal if the synchronization signal is changed from the enable to disable states, the detecting device waiting a predetermined time then turning the power input switching device off and thus the line voltage does not input into the power supply.

### BRIEF DESCRIPTION OF THE DRAWINGS

The invention can be more fully understood by reading the subsequent detailed description in conjunction with the examples and references made to the accompanying drawings, wherein:

FIG. 1 is a block diagram of a typical computer power management system;

FIG. 2 is a block diagram of an embodiment of a display power management system according to the invention;

FIG. 3 is a diagram of a detecting device of FIG. 2 according to the invention; and

FIG. 4 is a diagram of a power input switching device of FIG. 2 according to the invention.

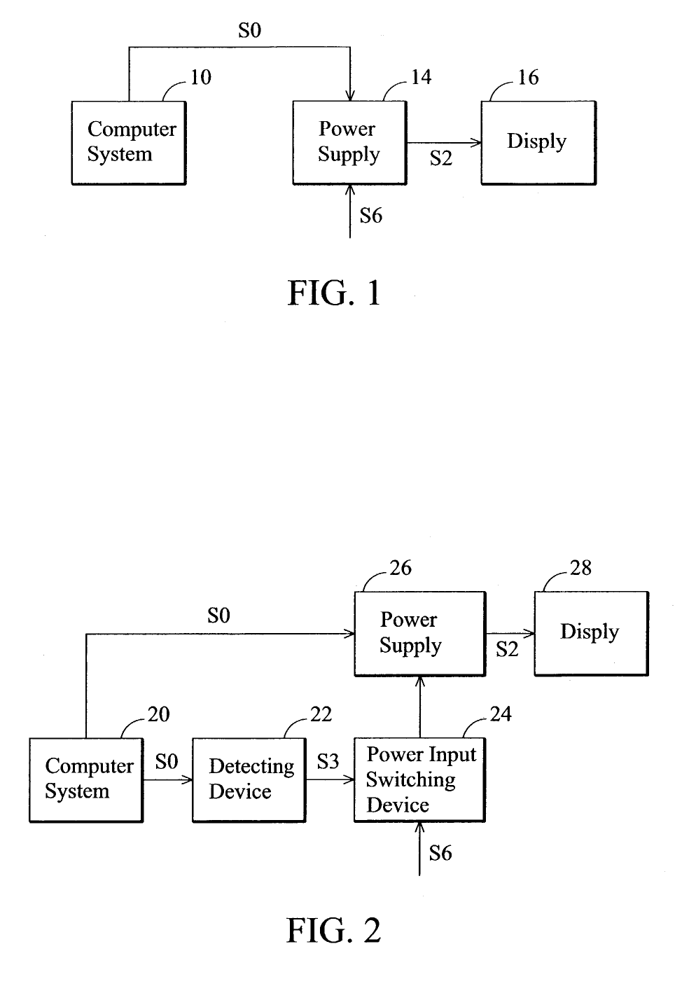

### DETAILED DESCRIPTION OF THE INVENTION

The same element function denotes the same reference number throughout the description.

FIG. 2 is a block diagram of an embodiment of a display, i.e. a liquid crystal display, power management system according to the invention. The embodiment includes devices as below.

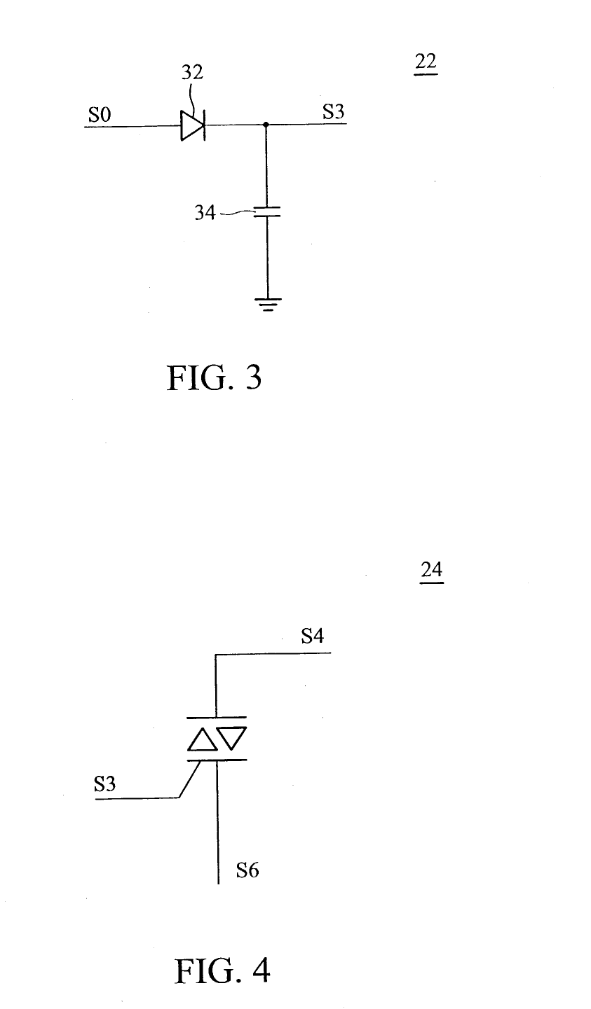

A detecting device 22 receives a synchronization signal S0 and outputs a switching signal s3. When a synchronization signal S0 changes from an enable state to a disable state for a predetermined time, the switching signal S3 is changed from the enable state to the disable state. The synchronization signal S0 is provided by the computer system 20 or the other switching device (not shown). An example of the detecting device 22 is shown in FIG. 3. The detecting device 22 includes a diode 32 and a capacitor 34. When the synchronization signal S0 is in the enable state, the diode 32 detects the peak voltage of the synchronization signal S0 and stores to the capacitor 34 in order to produce a high-level switching signal S3 through the peak voltage. When the synchronization signal S0 changes to the disable state, the capacitor discharges for a predetermined time until the peak voltage is down to be a cutoff voltage and thus output a low-level switching signal S3, wherein the determined time depends on the capacitance of the capacitor 34.

A power input switching device 24 is input an external power provided by a line voltage S6 and provides the line voltage S6 to a liquid crystal power supply 26 according to the switching signal S3. When the switching signal S3 is enabled, the line voltage S6 is provided to the power supply 26. When the switching signal S3 is disabled, the line voltage S6 provided to the power supply 26 is stopped. An example of the power input switching device 24 is shown in FIG. 4. The example can be a triple-state alternating current (TRIAC) diode. That is, when the switching signal S3 is enabled, the line voltage S6 is sent to the power input switching device 24 to provide the line voltage S6 to the power supply 26. When the switching signal S3 is disabled, the line voltage S6 cannot be sent to the power input switching device 24 so that the device 24 cannot provide the line voltage S6 to the power supply 26. Therefore, since no line voltage is provided to the power supply 26, the power supply consumes no power and thus the power save purpose is achieved.

The power supply 26 inputs the line voltage S6 provided by the power input switching device 24 and provides required power to the display 28. When the synchronization signal S0 is enabled, the power supply 26 provides required voltage to the display 28. When the synchronization signal S0 is disabled, the power supply 26 does not provide required voltage to the display 28 and so the power supply 26 does not provide any power to the display 28. Therefore, the power supply 26 and the display 28 do not consume any power as the synchronization signal S0 is in the disable state. Thus, the inventive power save purpose is achieved.

Additionally, the computer system 20 also includes a power required by the power supply 26 to provide the display 28 respectively to the normal or power-down mode according to the synchronization signal S0, when the synchronization signal S0 is input and a switching signal is output to the power supply. When the synchronization signal S0 is in the enable state, the power supply 26 provides required power by the display 28 with the normal mode. When the synchronization signal S0 is in the disable state, the power supply 26 provides required power by the display 28 with the power-down mode.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A power management system suitable for a display to enter an operation of a normal mode or power-down mode respectively according to a synchronization signal with enable state or disable state, comprising:
a power supply to convert a line voltage of a power source in order to provide to said display;
a power input switching device implemented between the power supply and the power source, to input the line voltage to the power supply when the power input switching device is open and not to input the line voltage to the power supply when the power input switching device is closed; and
a detecting device to close the power input switching device after detecting the synchronization signal changed from the enable state to disable state for a predetermined time.

2. The power management system of claim 1, wherein the power input switching device is a triple-state alternating current (TRIAC) diode.

3. The power management system of claim 1, wherein the detecting device includes a diode and a capacitor, and the diode detects the peak voltage of the synchronization signal and stores the peak voltage to the capacitor to turn on the power input switching device by the peak voltage when the synchronization is in the enable state and the capacitor discharges for a predetermined time until the peak voltage is down to a cutoff voltage to close the power input switching device when the synchronization is in the disable state.

4. The power management system of claim 3, wherein the predetermined time depends on the capacitance of the capacitor.

5. The power management system of claim 1, wherein the detecting device further comprising:
a switching signal sending to the power input switching device to control the power input switching device selectively being one state of open state and close state respectively to the state of the synchronization signal.

6. A power management system suitable for a display that receives an input image signal and converts the signal to an image display, comprising:
a power supply to convert a line voltage of a power source in order to provide to the display;
a TRIAC diode implemented between the power supply and the power source;
a diode; and
a capacitor;
wherein one end of the diode is connected to the input image signal, the other end of the diode is connected to one end of the capacitor and one control end of the TRIAC diode, and the other end of the capacitor is grounded, and wherein when the diode detects a peak voltage of the image signal and stores the peak voltage to the capacitor, the TRIAC diode is turned on by a voltage between two ends of the capacitor such that the power supply provides the voltage to the LCD; and when the diode does not detect the image signal and so causes the capacitor discharge for a predetermined time, the voltage between two ends of the capacitor causes the TRIAC diode opened and so the power supply does not provide the voltage to the LCD.

7. The power management system of claim 6, wherein the predetermined time depends on the capacitance of the capacitor.

8. A display with a power management function, the display selectively operating in one of a normal mode and a power-down mode respectively according to a synchronization signal with enable state or disable state, comprising:
a power supply to convert a line voltage of a power source in order to provide to said display;
a power input switching device implemented between the power supply and the power source, to input the line voltage to the power supply when the power input switching device is open and not to input the line voltage to the power supply when the power input switching device is closed; and
a detecting device to close the power input switching device after detecting the synchronization signal changed from the enable state to disable state for a predetermined time.

9. The display of claim 8, wherein the power input switching device is a triple-state alternating current (TRIAC) diode.

10. The display of claim 8, wherein the detecting device includes a diode and a capacitor, and the diode detects the peak voltage of the synchronization signal and stores the peak voltage to the capacitor to turn on the power input switching device by the peak voltage when the synchronization is in the enable state and the capacitor discharges for a predetermined time until the peak voltage is down to a cutoff voltage to close the power input switching device when the synchronization is in the disable state.

11. The display of claim 8,, wherein the predetermined time depends on the capacitance of the capacitor.
